(19) United States
(12) Patent Application Publication
(10) Pub. No.: US 2023/0314806 A1
(43) Pub. Date: Oct. 5, 2023

(54) SYSTEMS AND METHODS FOR ALIGNMENT OF OPTICAL COMPONENTS

(71) Applicant: Meta Platforms Technologies, LLC, Menlo Park, CA (US)

(72) Inventors: James Schultz, Redmond, WA (US); Zhiqiang Liu, Redmond, WA (US); Alex Ockfen, Bothell, WA (US)

(21) Appl. No.: 18/162,201

(22) Filed: Jan. 31, 2023

Related U.S. Application Data
(60) Provisional application No. 63/318,528, filed on Mar. 10, 2022.

(51) Int. Cl. G02B 27/01; G02B 6/42

(52) U.S. Cl. CPC G02B 27/0172; G02B 6/4224; G02B 6/4227; G02B 27/0176; G02B 2027/0112; G02B 2027/0169; G02B 2027/0178

(57) ABSTRACT

Head-mounted displays may include a frame, a light projector coupled to the frame, a waveguide configured to direct images from the light projector to a user’s eye, and at least one flexure element coupled to the frame and physically supporting the waveguide in the frame. Various other methods, systems, and devices are also disclosed.

### BRIEF DESCRIPTION OF THE DRAWINGS

This application claims the benefit of U.S. Provisional Pat. Application Serial No. 63/318,528, titled “SYSTEMS AND METHODS FOR ALIGNMENT OF OPTICAL COMPONENTS,” filed on 10 Mar. 2022, the entire disclosure of which is incorporated herein by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure

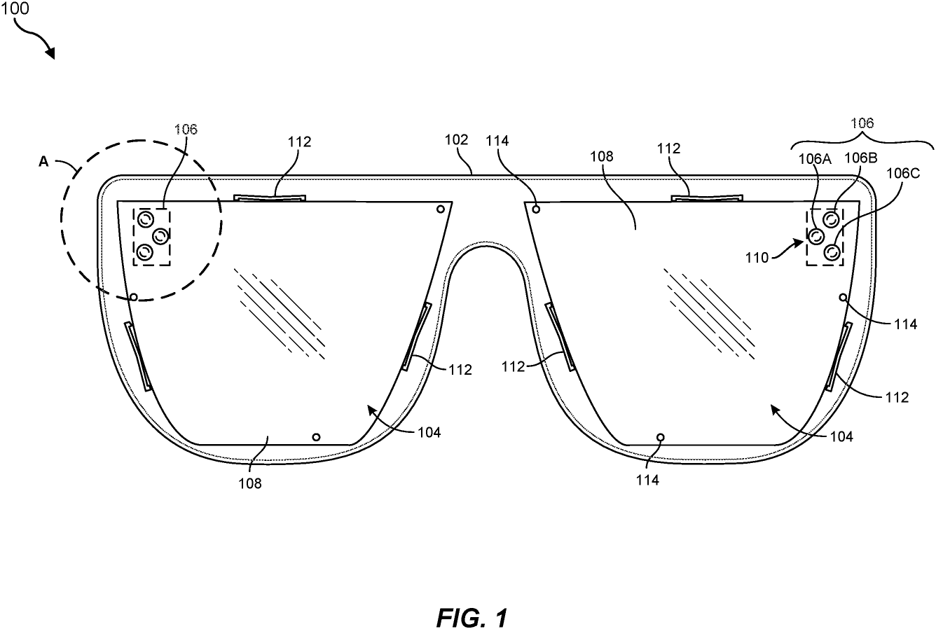

FIG. 1 is a plan view of a head-mounted display, according to at least one embodiment of the present disclosure.

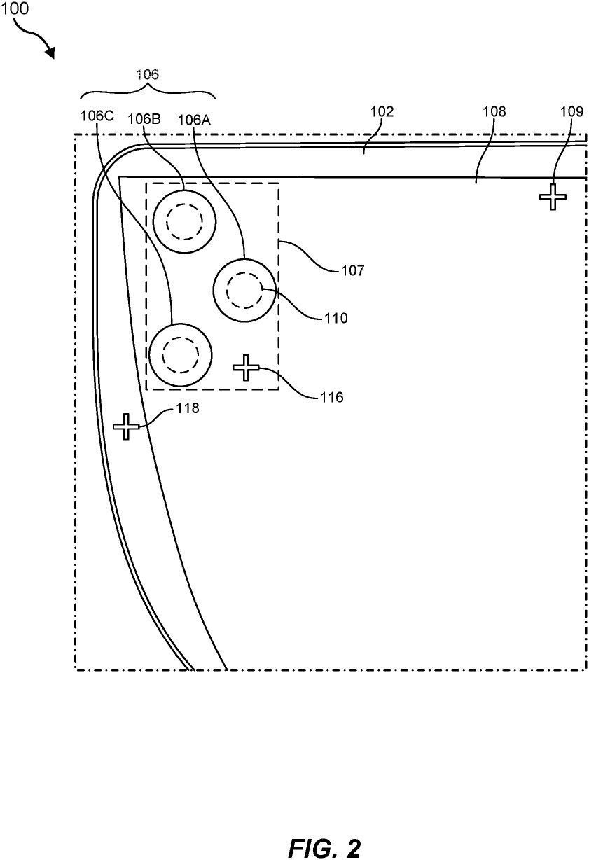

FIG. 2 is a detailed view of a light projector mounted to a frame of the head-mounted display, taken at dashed circle A of FIG. 1, according to at least one embodiment of the present disclosure.

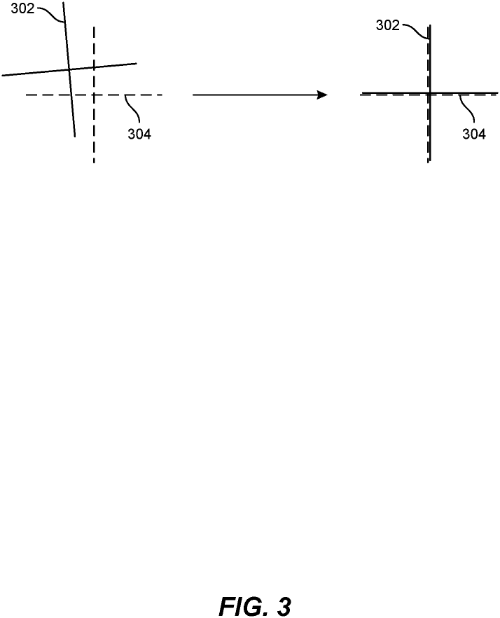

FIG. 3 illustrates optical alignment of a projected pattern as viewed by a camera, according to at least one embodiment of the present disclosure.

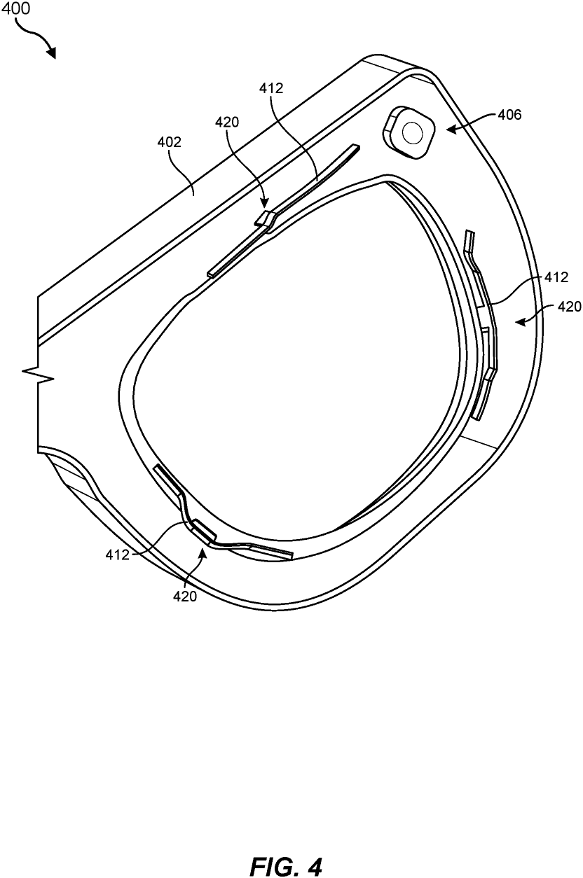

FIG. 4 is a perspective view of a portion of a head-mounted display including flexure elements and a light projector coupled to a frame, according to at least one embodiment of the present disclosure.

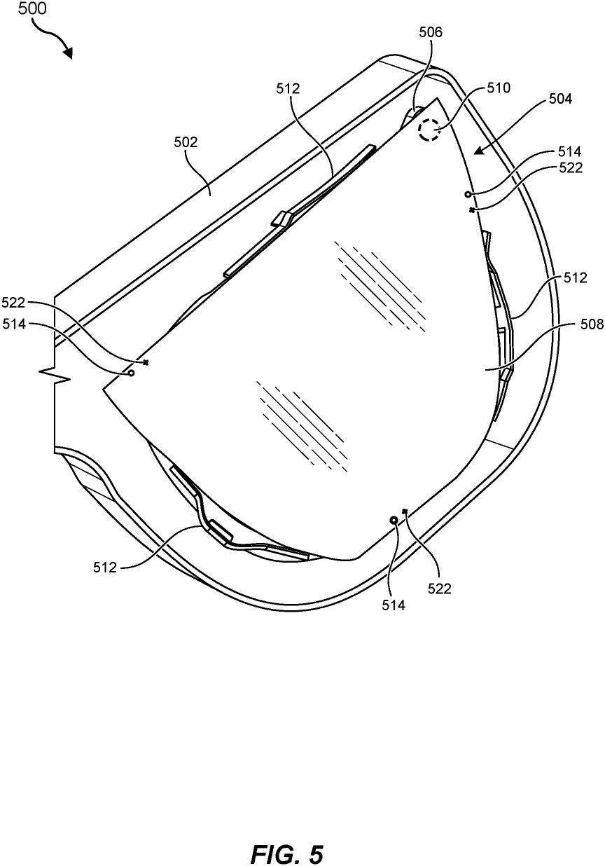

FIG. 5 is a perspective view of a portion of a head-mounted display including a waveguide mounted to a frame with flexure elements, according to at least one embodiment of the present disclosure.

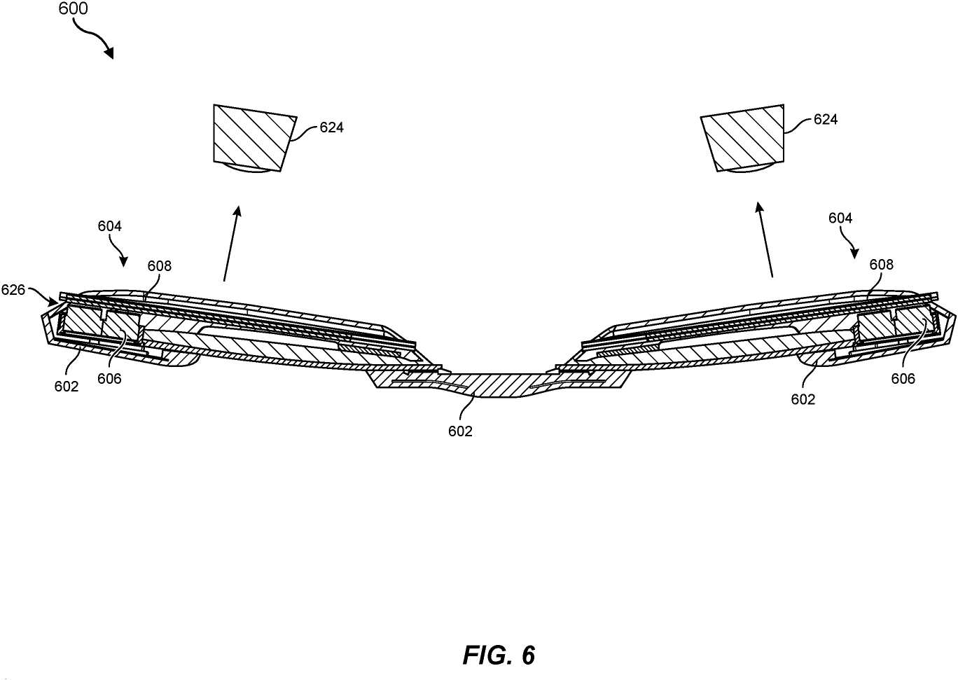

FIG. 6 is a cross-sectional view of a head-mounted display with alignment cameras, according to at least one embodiment of the present disclosure.

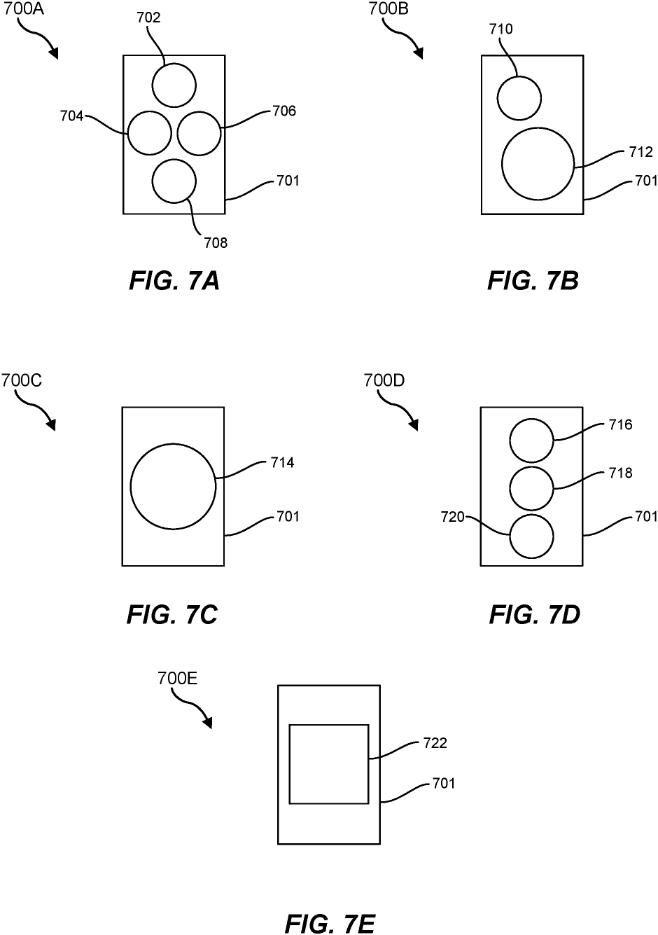

FIGS. 7A-7E illustrate various respective configurations of light projectors that may be used in head-mounted displays, according to several embodiments of the present disclosure.

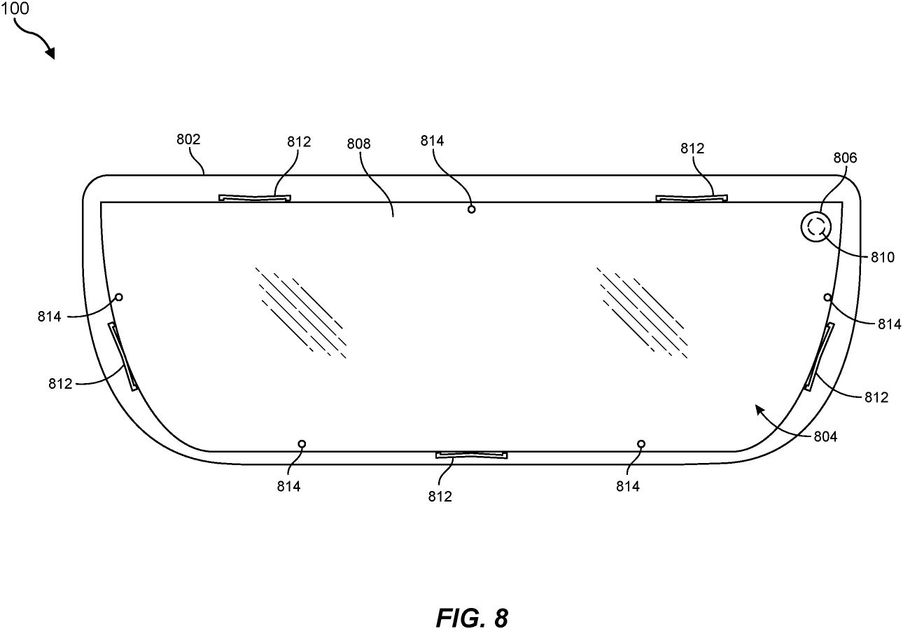

FIG. 8 is a plan view of a head-mounted display, according to at least one additional embodiment of the present disclosure.

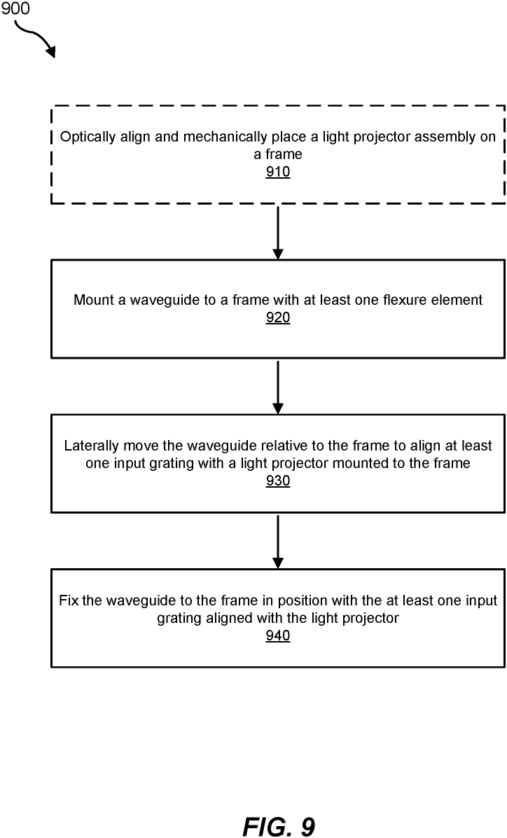

FIG. 9 is a flowchart illustrating a method of assembling a head-mounted display, according to at least one embodiment of the present disclosure.

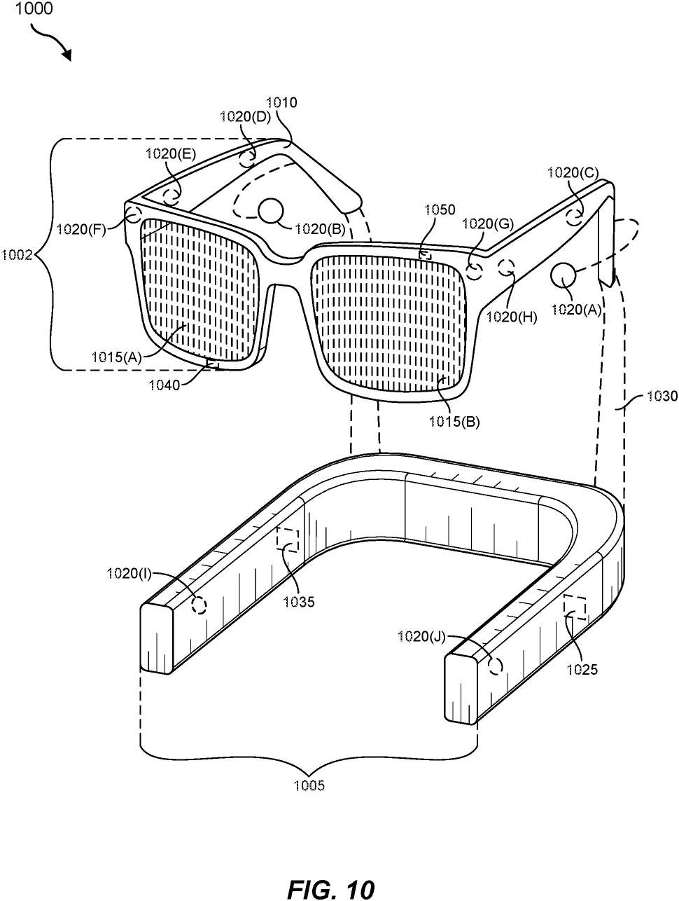

FIG. 10 is an illustration of example augmented-reality glasses that may be used in connection with embodiments of this disclosure.

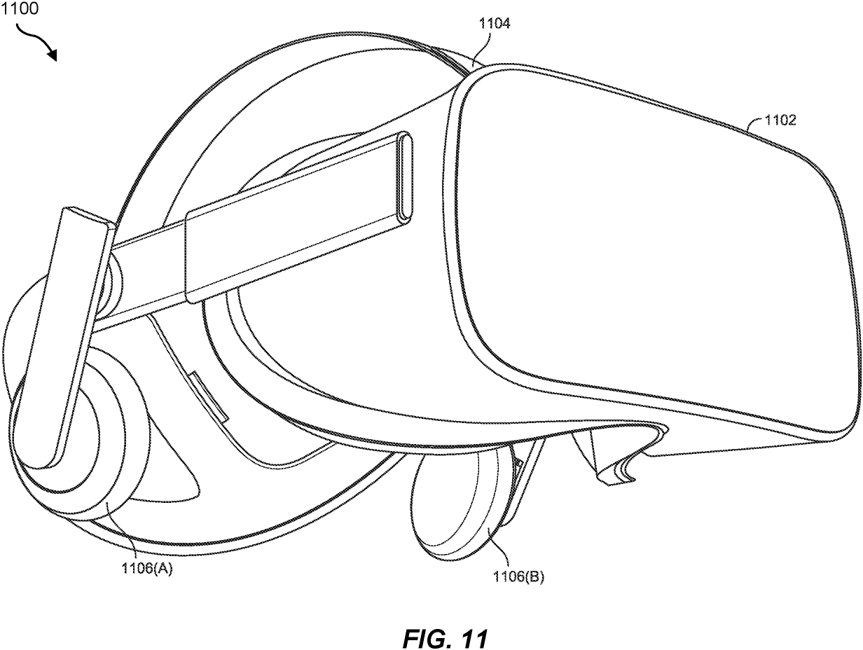

FIG. 11 is an illustration of an example virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the appendices and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Head-mounted displays (HMDs) including one or more near-eye displays are often used to present visual content to a user for use in artificial-reality applications. One type of near-eye display includes a waveguide that directs light from a projector to a location in front of the user’s eyes. Because of the visual sensitivity of human eyes, slight deviations in optical quality can be very apparent to the user. Proper alignment of projectors and waveguides with each other, relative to the user, and relative to the overall sensory system can be important to inhibit such deviations and to improve the user’s experience viewing visual content presented by near-eye displays.

The present disclosure is generally directed to systems and methods for aligning optical components of near-eye displays, such as for aligning waveguides with corresponding projectors. For example, embodiments of the present disclosure include head-mounted displays that may include a frame with a light projector coupled to the frame. A waveguide may be configured to direct images from the light projector to a user’s eye. At least one flexure element that may be coupled to the frame may physically support the waveguide in the frame. Such configurations may enable independent alignment of the light projector and the waveguide relative to each other and/or relative to the frame of the head-mounted display. The independent alignment may facilitate a reduction of deviations in optical quality, which may in turn improve users’ experience with such head-mounted displays. In addition, the flexure elements may protect the waveguide in a drop event or other physical jarring of the near-eye displays by dampening movement of the waveguide relative to the frame.

With reference to FIGS. 1 and 2, the following will describe example head-mounted displays and components thereof, according to embodiments of the present disclosure. The optical alignment of a projected pattern as viewed by a camera will then be described with reference to FIG. 3. Next, various additional embodiments of head-mounted displays and components thereof will be described with reference to FIGS. 4-8. With reference to FIG. 9, an example method of assembling a head-mounted display will then be described. Finally, example augmented-reality glasses and virtual-reality headsets will be descried with reference to FIGS. 10 and 11.

FIG. 1 is a plan view of a head-mounted display 100, according to at least one embodiment of the present disclosure. The head-mounted display 100 may include a frame 102 and a display assembly 104 coupled to the frame 102. The display assembly 104 for each eye may include a light projector 106 (shown in dashed lines in FIG. 1) and a waveguide 108 configured to direct images from the light projector 106 to a user’s eye. In some examples, the light projector 106 may include a plurality of (e.g., three) subprojectors 106A, 106B, and 106C that are configured to project light of different wavelengths (e.g., colors, such as red, green, blue, infrared, etc.). The waveguide 108 may include at least one input grating 110 positioned adjacent to and optically aligned with the light projector 106. The input grating 110 may be configured to enable light from the subprojectors 106A, 106B, and 106C to enter into the waveguide 108 to be directed to the center of the waveguide 108 for presentation to the user’s eye. For example, as shown in FIG. 1 in dashed lines, the input grating 110 may include three optical apertures respectively aligned with the three subprojectors 106A, 106B, and 106C of the light projector 106.

In some examples, the head-mounted display 100 may be implemented in the form of augmented-reality glasses. Accordingly, the waveguide 108 may be at least partially transparent to visible light to allow the user to view a real-world environment through the waveguide 108. Images presented to the user’s eye by the light projectors 106 may overlay the user’s view of the real-world environment.

The waveguide 108 may be physically supported in the frame 102 at least partially by at least one flexure element 112 (e.g., three flexure elements 112 in the embodiment shown in FIG. 1). The flexure element(s) 112 may abut against an outer peripheral edge of the waveguide 108. The flexure element(s) 112 may include a flexible material (e.g., metal, polymer, composite, etc.) configured to apply an inward biasing force against the waveguide 108 to hold the waveguide 108 laterally in place relative to the frame and to the light projector 106. For example, the flexure element(s) 112 may be at least slightly flexed outward by the waveguide 108, which may result in the inward biasing force applied on the waveguide 108 by the flexure element(s) 112.

These flexure element(s) 112 may facilitate proper placement and alignment of the waveguide 108 relative to the frame 102 and/or light projector 106 during assembly, and may further secure the waveguide 108 in place after assembly is complete. For example, as explained further below, the light projectors 106 may first be aligned with and secured to the frame. Then, the input gratings 110 of the waveguides 108 may be held in place by the flexure element(s) 112 and optically aligned with the light projectors 106.

In some embodiments, the waveguide 108 may also be secured to the frame 102 with an adhesive material, one or more fasteners, an adhesive, a clip, etc., such as after completion of the optical alignment of the waveguides 108 with the respective light projectors 106. For example, an adhesive material may be positioned between the waveguide 108 and the frame 102 at multiple (e.g., two, three, or more than three) distinct locations 114 to maintain the relative position between the waveguide 108 and the light projector 106. In additional embodiments, the waveguide 108 may be secured to the frame 102 in a continuous manner, such as along one or more peripheral edges of the waveguide 108 by an adhesive, a clip, a frame cover element, etc.

The flexure element(s) 112 may be in the form of a flexible beam, as shown in FIG. 1. In additional embodiments, the flexure element(s) 112 may be or include a coil spring, cantilevered beam, beam with a central support, curved (e.g., preloaded) beam with end supports, a bistable element, a spring pin, etc. In some examples, the flexure element(s) 112 may protect the waveguide 108 in a drop event or other jarring of the head-mounted display 100 by dampening movement of the waveguide 108 relative to the frame 102.

FIG. 2 is a detailed view of the light projector 106 mounted to the frame 102 of the head-mounted display 100, taken at dashed circle A of FIG. 1, according to at least one embodiment of the present disclosure. As shown in FIG. 2, the light projector 106 may be mounted on the frame 102 of the head-mounted display 100, such as in an upper corner of the frame 102. The first subprojector 106A may include a blue light source, the second subprojector 106B may include a red light source, and the third subprojector 106C may include a green light source. Other colors and arrangements of the subprojectors 106A, 106B, and 106C may also be possible.

To assemble the head-mounted display 100, the three subprojectors 106A, 106B, and 106C may be initially assembled with each other (e.g., three subprojectors mounted to a common substrate 107, three collimating lenses aligned on the three subprojectors, etc.) to form the light projector 106 as a unit. The light projector 106 (e.g., the substrate 107 of the light projector 106) may include one or more projector fiducial marks 116, which may be used in optically aligning (e.g., positioning, orienting, securing) the light projector 106 with the frame 102. In some examples, the frame 102 may likewise include one or more frame fiducial marks 118 to assist in the optical alignment of the light projector 106 with the frame 102.

Optical alignment of the light projector 106 relative to the frame 102 may involve viewing the light projector 106 and/or frame 102 during placement of the light projector 106 in or on the frame 102 with one or more cameras, which may be used to identify the location and orientation of the projector fiducial mark(s) 116 relative to the location and orientation of the frame fiducial mark(s) 118. The projector fiducial mark(s) 116 and the frame fiducial mark(s) 118 are each shown in FIG. 2 in the shape of a plus sign. In additional examples, other shapes, physical features (e.g., of the light projector 106 and/or of the frame 102), reflective surfaces, or other optical identifiers may be used to optically align the light projector 106 relative to the frame 102. In some embodiments, the light projector 106 may be aligned relative to the frame 102 using an image projected by the light projector 106, such as is explained below with reference to FIG. 3.

After the light projector 106 is aligned with and secured to the frame 102, the waveguide 108 may be aligned with the light projector 106 and secured to the frame 102. For example, the waveguide 108 may include a waveguide fiducial mark 109, which may be used in optically aligning (e.g., positioning, orienting, securing) the waveguide 108 to the frame 102 and/or to the light projector 106. In addition, the input gratings 110 of the waveguide 108 may be optically aligned with the subprojectors 106A, 106B, and 106C. In some examples, the input gratings 110 may be smaller than respective apertures of the subprojectors 106A, 106B, and 106C as shown in FIG. 2. In additional examples, the input gratings 110 may be substantially the same size as or larger than the respective apertures of the subprojectors 106A, 106B, and 106C.

FIG. 3 illustrates optical alignment of a projected pattern 302 as viewed by a camera, according to at least one embodiment of the present disclosure. The projected pattern 302 may be aligned with a camera target 304. The projected pattern 302 may be produced by a light projector, such as the light projector 106 described above. One or more cameras may view the projected pattern 302 and compare the location and orientation of the projected pattern 302 to the camera target 304. The light projector and/or a frame to which the light projector is to be mounted may be moved (e.g., laterally shifted, angled, rotated, etc.) to align the projected pattern 302 with the camera target 304 to an acceptable resolve (e.g., within an acceptable tolerance) before the light projector is fixed in position relative to the frame. In some examples, the alignment of the projected pattern 302 with the camera target 304 may be performed while exposing the light projector 106 and the frame 102 to conditions that may be expected during use of the resulting assembly. For example, a heat load may be applied to the light projector 106 during alignment to mimic thermal loading that may occur during use.

FIG. 4 is a perspective view of a portion of a head-mounted display 400 including flexure elements 412 and a light projector 406 coupled to a frame 402, according to at least one embodiment of the present disclosure. In at least some respects, the head-mounted display 400 may be similar to the head-mounted display 100 described above. For example, the head-mounted display 400 shown in FIG. 4 may include the frame 402, the light projector 406 coupled to the frame 402, and flexure elements 412 for holding a waveguide (not shown in FIG. 4 to more clearly view features below the waveguide) in place relative to the frame 402.

As shown in FIG. 4, in some embodiments each of the flexure elements 412 may include a strip of material shaped and sized to be positioned along a peripheral edge of a corresponding waveguide. Each of the flexure elements 412 may be mounted to the frame 402 at one or more coupling points 420 (e.g., a central coupling point 420). Thus, portions (e.g., flexible arms) of the flexure elements 412 may be free to flex to exert inward pressure on the waveguide, such as during assembly of the waveguide to the frame 402. The flexible arms of the flexure elements 412 may be initially bent or otherwise formed inward to be deflected outward by the waveguide when the waveguide is positioned between the flexure elements 412. The deflection of the flexible arms may result in a lateral biasing force inward against the waveguide.

In additional embodiments, the one or more of the flexure elements 412 may have a shape and/or configuration different from that shown in FIG. 4. For example, the flexure element 412 may be or include a cantilever beam extending in one direction away from the coupling point 420. In another example, the flexure element 412 may be a flexible beam suspended between two coupling points 420 at ends of the flexible beam. In such a case, the flexible beam may be compressed and pre-loaded between the two coupling points 420 to bend inward toward the waveguide. In additional examples, coil springs, leaf springs, bistable elements, or other biasing elements may be used in place of or in addition to the beams described above.

Moreover, any suitable number of flexure elements 412 may be used. For example, one flexure element 412 may be used on one side of the waveguide and an inflexible stop may be used on an opposing side of the waveguide. In other examples, two, three, four, or more than four flexure elements 412 may be used.

As described above with reference to FIGS. 1 and 2, the projectors 106 may include multiple subprojectors 106A, 106B, and 106C. As illustrated in FIG. 4, the projector 406 may include a single light source, which may be configured to project light in a single color or in multiple colors and wavelengths. Additional example arrangements of subprojectors are shown in FIGS. 7A-7E and are described below.

FIG. 5 is a perspective view of a portion of a head-mounted display 500 including a waveguide 508 mounted to a frame 502 with flexure elements 512, according to at least one embodiment of the present disclosure. In at least some respects, the head-mounted display 500 may be similar to the head-mounted displays 100 and/or 400 described above. For example, the head-mounted display 500 of FIG. 5 may include a frame 502, a display assembly 504 including a light projector 506 and a waveguide 508, and flexure elements 512 configured to physically support the waveguide 508 in the frame 502. The waveguide 508 may include an input grating 510 positioned over and aligned with the light projector 506 to enable light from the light projector 506 to be directed into the waveguide 508 and ultimately to a central portion of the waveguide 508 to be presented to an eye of a user.

As shown in FIG. 5, the waveguide 508 may also include waveguide fiducial marks 522 to assist in optically aligning the waveguide 508 with the frame 502 and with the light projector 506. The waveguide fiducial marks 522 may be optically recognizable, such as by a camera, to facilitate determining a precise location and orientation of the waveguide 508.

After being held between the flexure elements 512, the waveguide 508 may be moved (e.g., laterally shifted, rotated, etc.) into a location to align the input grating 510 with the light projector 506 to an acceptable tolerance. This lateral movement of the waveguide 508 may at least slightly flex the flexure elements 512, which may result in the flexure elements applying an inward force against a peripheral edge of the waveguide 508. Upon properly aligning the input grating 510 with the light projector 506, the waveguide 508 may be fixed in place on the frame 502, such as with an adhesive material, fastener, etc., at one or more distinct locations 514. In some examples, the alignment of the waveguide 508 in the frame 502 may be performed while exposing the waveguide 508 and the frame 502 to conditions that may be expected during use of the resulting assembly. For example, a heat load may be applied to the waveguide 508 during alignment to mimic thermal loading that may occur during use.

FIG. 6 is a cross-sectional view of a head-mounted display 600 with alignment cameras 624, according to at least one embodiment of the present disclosure. In at least some respects, the head-mounted display 600 may be similar to the head-mounted displays 100, 400, and/or 500 described above. For example, the head-mounted display 600 may include a frame 602, a display assembly 604 including a light projector 606 and a waveguide 608 mounted to the frame 602, and flexure elements (not visible in the view of FIG. 6) for physically supporting the waveguide 608 in the frame 602.

The alignment cameras 624 may be used during assembly of the head-mounted display 600 to optically align the light projector 606 with the frame 602 and/or to optically align the waveguide 608 (e.g., input gratings of the waveguide 608) with the light projector 606. For example, the alignment cameras 624 may be used to detect the location and/or orientation of a fiducial mark (e.g., the projector fiducial marks 116, the frame fiducial marks 118, the waveguide fiducial marks 522, etc.), a physical component or feature, a reflective material, etc. In additional examples, the alignment cameras 624 may be used to detect a location and/or orientation of a projected pattern (e.g., the projected pattern 302) relative to a target (e.g., the camera target 304). This detected information may be used to adjust a position and/or orientation of the light projector 606 relative to the frame 602 and/or of the waveguide 608 relative to the light projector 606 and/or frame 602.

As shown in FIG. 6, a gap 626 may be present between the waveguide 608 and the light projector 606. Thus, in some embodiments, the waveguide 608 and the light projector 606 may not be directly coupled to each other. Rather, the light projector 606 and the waveguide 608 may each be separately mounted to the frame 602 and decoupled from each other. This may allow for adjustments in relative position and/or orientation between the light projector 606 and the waveguide 608 during assembly. In addition, the decoupling of the light projector 606 and the waveguide 608 may improve the precision of a projected light output from the light projector 606 through the waveguide 608 to the user’s eye compared to a pre-assembled display assembly 604. Moreover, if placement of one of the light projectors 606 or the waveguide 608 fails, or if the frame 602, light projector 606, or waveguide is damaged or defective, then it may be less expensive to replace parts compared to when a pre-assembled display assembly 604 is used.

FIGS. 7A-7E illustrate various respective configurations of light projectors 700A-700E that may be used in head-mounted displays, such as any of the head-mounted displays described herein, according to several embodiments of the present disclosure.

As shown in FIG. 7A, a light projector 700A may include four subprojectors 702, 704, 706, 708 arranged on a substrate 701. The four subprojectors 702, 704, 706, 708 may be positioned on the substrate 701 in any suitable configuration, such as in a diamond shape as shown in FIG. 7A, in a straight line, in a curve, in a rectangle shape, etc. The four subprojectors 702, 704, 706, 708 may be configured to respectively emit light of four different wavelengths, such as red, green, blue, and infrared. Each of the subprojectors 702, 704, 706, 708 may include an array of pixels that may be selectively activated to be combined to create an image for display to a user. In some examples, one of the subprojectors 702, 704, 706, 708 may be configured to emit infrared light, such as a structured infrared light pattern, an infrared glint, or a flood of infrared light to facilitate eye tracking.

As shown in FIG. 7B, a light projector 700B may include two subprojectors 710, 712 on the substrate 701. FIG. 7B illustrates that the subprojectors 710 may be different sizes. For example, the subprojector 710 may be configured to emit light of one wavelength or range of wavelengths and the larger subprojector 712 may be configured to emit light of another, different wavelength or range of wavelengths. In one example, the subprojector 710 may be configured to emit infrared light (e.g., for eye tracking) and the larger subprojector 712 may be configured to emit visible light (e.g., for producing an image for display to the user).

As shown in FIG. 7C, a light projector 700C may include a single light source 714 on the substrate 701. The single light source 714 may be configured to emit light of a single wavelength or of multiple wavelengths. For example, the single light source 714 may include an array of pixels capable of emitting various colors and patterns.

As shown in FIG. 7D, a light projector 700D may include three subprojectors 716, 718, 720. Three subprojectors 106A, 106B, 106C were illustrated in FIGS. 1 and 2 in a triangular configuration. However, as illustrated in FIG. 7D, the three subprojectors 716, 718, 720 may be arranged in a line.

In examples and figures described above, the light projectors and light sources are illustrated as each having a circular shape. However, the present disclosure is not so limited. For example, as shown in FIG. 7E, a light projector 700E may include one or more light sources 722 having a non-circular shape, such as square or rectangular.

Accordingly, light projectors of various shapes, sizes, and arrangements of light sources and/or subprojectors may be used in conjunction with embodiments of the present disclosure.

FIG. 8 is a plan view of a head-mounted display 800, according to at least one additional embodiment of the present disclosure. In some respects, the head-mounted display 800 may be similar to the head-mounted displays 100, 400, 500, and/or 600 described above. For example, the head-mounted display 800 may include a frame 802, a display assembly 804 including a light projector 806 and a waveguide 808 mounted to the frame 802, and flexure elements 812 physically supporting the waveguide 808 in the frame 802. The waveguide 808 may include an input grating 810 positioned over and aligned with the light projector 806 to enable light from the light projector 806 to be directed into the waveguide 808 and to a central portion of the waveguide 808 to be presented to eyes of a user.

As illustrated in FIG. 8, the waveguide 808 may be a single waveguide 808 for displaying images generated by the light projector 806 to both eyes of a user. As explained above, the flexure elements 812 may apply a laterally inward force against a peripheral edge of the waveguide 808, which may facilitate alignment of the waveguide 808 (e.g., the input grating 810 thereof) with the light projector 806 during assembly. After the waveguide 808 is aligned with the light projector 806, in some embodiments the waveguide may be secured in place relative to the frame 802 and to the light projector 806 at one or more coupling locations 814.

Although FIG. 8 illustrates the light projector 806 as including only a single light source, the present disclosure is not so limited. In additional examples, multiple light sources and/or subprojectors may be used with the waveguide 808 to produce an image for display to the user. The multiple light sources and/or subprojectors may be positioned adjacent to each other (e.g., in a single corner of the waveguide 808 near the light projector 806 depicted in FIG. 8) or in other locations (e.g., in left and right upper corners of the waveguide 808, near a bottom of the waveguide 808, etc.).

FIG. 9 is a flowchart illustrating a method 900 of assembling a head-mounted display, according to at least one embodiment of the present disclosure. At operation 910, optionally, a light projector assembly may be optically aligned with and mechanically placed on a frame. Operation 910 may be performed in a variety of ways, such as in the manner described above with reference to FIG. 3.

At operation 920, a waveguide may be mounted to the frame with at least one flexure element, which may be coupled to the frame. Operation 920 may be performed in a variety of ways, such as in any of the manners described above. For example, the at least one flexure element may be mounted to the frame via one or more coupling points, and the at least one flexure element may apply a laterally inward force against a peripheral edge of the waveguide.

At operation 930, the waveguide may be laterally moved (e.g., laterally shifted, rotated, etc.) relative to the frame to align at least one input grating of the waveguide with a light projector mounted to the frame. Operation 930 may be performed in a variety of ways, such as in any of the manners described above. The lateral movement of the waveguide may flex the at least one flexure element outward, resulting in an application of inward force by the at least one flexure against the waveguide. The waveguide may be moved in any lateral direction and may be rotated to align the at least one input grating with the light projector.

At operation 940, the waveguide may be fixed to the frame in position with the at least one input grating aligned with the light projector. Operation 940 may be performed in a variety of ways, such as in any of the ways described above. For example, an adhesive, clip, frame cover, fastener, weld, or the like may be used to fix the waveguide to the frame. In some embodiments, the position and orientation of the waveguide relative to the frame may be optically determined prior to fixing the waveguide to the frame.

Accordingly, the present disclosure includes head-mounted displays and methods that facilitate improved alignment of optical components with each other and with a frame of the head-mounted displays. The improved alignment of the optical components may inhibit (e.g., reduce or eliminate) optical deviations that would otherwise detract from a user’s visual experience while using the head-mounted displays. In addition, flexure elements of the present disclosure may protect waveguides in a drop event or other physical jarring. Embodiments of the present disclosure include light projectors and corresponding waveguides that may be independently aligned and oriented relative to each other and/or relative to the frame.

Embodiments of the present disclosure may include or be implemented in conjunction with various types of artificial-reality systems. Artificial-reality systems may be implemented in a variety of different form factors and configurations. Some artificial-reality systems may be designed to work without near-eye displays (NEDs). Other artificial-reality systems may include an NED that also provides visibility into a real-world environment (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, the augmented-reality system 1000 may include an eyewear device 1002 with a frame 1010 configured to hold a left display device 1015(A) and a right display device 1015(B) in front of a user’s eyes. The display devices 1015(A) and 1015(B) may act together or independently to present an image or series of images to a user. While the augmented-reality system 1000 includes two displays, embodiments of this disclosure may be implemented in augmented-reality systems with a single NED or more than two NEDs.

In some embodiments, the augmented-reality system 1000 may include one or more sensors, such as sensor 1040. The sensor 1040 may generate measurement signals in response to motion of the augmented-reality system 1000 and may be located on substantially any portion of the frame 1010. The sensor 1040 may represent one or more of a variety of different sensing mechanisms, such as a position sensor, an inertial measurement unit (IMU), a depth camera assembly, a structured light emitter and/or detector, or any combination thereof. In some embodiments, the augmented-reality system 1000 may or may not include the sensor 1040 or may include more than one sensor. In embodiments in which the sensor 1040 includes an IMU, the IMU may generate calibration data based on measurement signals from the sensor 1040. Examples of the sensor 1040 may include, without limitation, accelerometers, gyroscopes, magnetometers, other suitable types of sensors that detect motion, sensors used for error correction of the IMU, or some combination thereof.

In some examples, the augmented-reality system 1000 may also include a microphone array with a plurality of acoustic transducers 1020(A)- 1020(J), referred to collectively as acoustic transducers 1020. The acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on the frame 1010, and/or acoustic transducers 1020(I) and 1020(J), which may be positioned on a corresponding neckband 1005.

In some embodiments, one or more of the acoustic transducers 1020(A)-(J) may be used as output transducers (e.g., speakers). For example, the acoustic transducers 1020(A) and/or 1020(B) may be earbuds or any other suitable type of headphone or speaker.

The configuration of the acoustic transducers 1020 of the microphone array may vary. While the augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on the frame 1010, an orientation associated with each acoustic transducer 1020, or some combination thereof.

The acoustic transducers 1020(A) and 1020(B) may be positioned on different parts of the user’s ear, such as behind the pinna, behind the tragus, and/or within the auricle or fossa. Or, there may be additional acoustic transducers 1020 on or surrounding the ear in addition to the acoustic transducers 1020 inside the ear canal. Having an acoustic transducer 1020 positioned next to an ear canal of a user may enable the microphone array to collect information on how sounds arrive at the ear canal. By positioning at least two of the acoustic transducers 1020 on either side of a user’s head (e.g., as binaural microphones), the augmented-reality device 1000 may simulate binaural hearing and capture a 3D stereo sound field around about a user’s head. In some embodiments, the acoustic transducers 1020(A) and 1020(B) may be connected to the augmented-reality system 1000 via a wired connection 1030, and in other embodiments the acoustic transducers 1020(A) and 1020(B) may be connected to the augmented-reality system 1000 via a wireless connection (e.g., a BLUETOOTH connection). In still other embodiments, the acoustic transducers 1020(A) and 1020(B) may not be used at all in conjunction with the augmented-reality system 1000.

The acoustic transducers 1020 on the frame 1010 may be positioned in a variety of different ways, including along the length of the temples, across the bridge, above or below the display devices 1015(A) and 1015(B), or some combination thereof. The acoustic transducers 1020 may also be oriented such that the microphone array is able to detect sounds in a wide range of directions surrounding the user wearing the augmented-reality system 1000. In some embodiments, an optimization process may be performed during manufacturing of the augmented-reality system 1000 to determine relative positioning of each acoustic transducer 1020 in the microphone array.

In some examples, the augmented-reality system 1000 may include or be connected to an external device (e.g., a paired device), such as the neckband 1005. The neckband 1005 generally represents any type or form of paired device. Thus, the following discussion of the neckband 1005 may also apply to various other paired devices, such as charging cases, smart watches, smart phones, wrist bands, other wearable devices, hand-held controllers, tablet computers, laptop computers, other external compute devices, etc.

As shown, the neckband 1005 may be coupled to the eyewear device 1002 via one or more connectors. The connectors may be wired or wireless and may include electrical and/or non-electrical (e.g., structural) components. In some cases, the eyewear device 1002 and neckband 1005 may operate independently without any wired or wireless connection between them. While FIG. 10 illustrates the components of the eyewear device 1002 and neckband 1005 in example locations on the eyewear device 1002 and neckband 1005, the components may be located elsewhere and/or distributed differently on the eyewear device 1002 and/or neckband 1005. In some embodiments, the components of the eyewear device 1002 and neckband 1005 may be located on one or more additional peripheral devices paired with the eyewear device 1002, neckband 1005, or some combination thereof.

Pairing external devices, such as the neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of the augmented-reality system 1000 may be provided by a paired device or shared between a paired device and an eyewear device, thus reducing the weight, heat profile, and form factor of the eyewear device overall while still retaining desired functionality. For example, the neckband 1005 may allow components that would otherwise be included on an eyewear device to be included in the neckband 1005 since users may tolerate a heavier weight load on their shoulders than they would tolerate on their heads. The neckband 1005 may also have a larger surface area over which to diffuse and disperse heat to the ambient environment. Thus, the neckband 1005 may allow for greater battery and computation capacity than might otherwise have been possible on a standalone eyewear device. Since weight carried in the neckband 1005 may be less invasive to a user than weight carried in the eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

The neckband 1005 may be communicatively coupled with the eyewear device 1002 and/or to other devices. These other devices may provide certain functions (e.g., tracking, localizing, depth mapping, processing, storage, etc.) to the augmented-reality system 1000. In the embodiment of FIG. 10, the neckband 1005 may include two acoustic transducers (e.g., 1020(I) and 1020(J)) that are part of the microphone array (or potentially form their own microphone subarray). The neckband 1005 may also include a controller 1025 and a power source 1035.

The acoustic transducers 1020(I) and 1020(J) of the neckband 1005 may be configured to detect sound and convert the detected sound into an electronic format (analog or digital). In the embodiment of FIG. 10, the acoustic transducers 1020(I) and 1020(J) may be positioned on the neckband 1005, thereby increasing the distance between the neckband acoustic transducers 1020(I) and 1020(J) and other acoustic transducers 1020 positioned on the eyewear device 1002. In some cases, increasing the distance between the acoustic transducers 1020 of the microphone array may improve the accuracy of beamforming performed via the microphone array. For example, if a sound is detected by the acoustic transducers 1020(C) and 1020(D) and the distance between the acoustic transducers 1020(C) and 1020(D) is greater than, e.g., the distance between the acoustic transducers 1020(D) and 1020(E), the determined source location of the detected sound may be more accurate than if the sound had been detected by the acoustic transducers 1020(D) and 1020(E).

The controller 1025 of the neckband 1005 may process information generated by the sensors on the neckband 1005 and/or augmented-reality system 1000. For example, the controller 1025 may process information from the microphone array that describes sounds detected by the microphone array. For each detected sound, the controller 1025 may perform a direction-of-arrival (DOA) estimation to estimate a direction from which the detected sound arrived at the microphone array. As the microphone array detects sounds, the controller 1025 may populate an audio data set with the information. In embodiments in which the augmented-reality system 1000 includes an inertial measurement unit, the controller 1025 may compute all inertial and spatial calculations from the IMU located on the eyewear device 1002. A connector may convey information between the augmented-reality system 1000 and the neckband 1005 and between the augmented-reality system 1000 and the controller 1025. The information may be in the form of optical data, electrical data, wireless data, or any other transmittable data form. Moving the processing of information generated by the augmented-reality system 1000 to the neckband 1005 may reduce weight and heat in the eyewear device 1002, making it more comfortable to the user.

The power source 1035 in the neckband 1005 may provide power to the eyewear device 1002 and/or to the neckband 1005. The power source 1035 may include, without limitation, lithium-ion batteries, lithium-polymer batteries, primary lithium batteries, alkaline batteries, or any other form of power storage. In some cases, the power source 1035 may be a wired power source. Including the power source 1035 on the neckband 1005 instead of on the eyewear device 1002 may help better distribute the weight and heat generated by the power source 1035.

As noted, some artificial-reality systems may, instead of blending an artificial reality with actual reality, substantially replace one or more of a user’s sensory perceptions of the real world with a virtual experience. One example of this type of system is a head-worn display system, such as the virtual-reality system 1100 in FIG. 11, that mostly or completely covers a user’s field of view. The virtual-reality system 1100 may include a front rigid body 1102 and a band 1104 shaped to fit around a user’s head. The virtual-reality system 1100 may also include output audio transducers 1106(A) and 1106(B). Furthermore, while not shown in FIG. 11, the front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in the augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user’s refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer’s eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in the augmented-reality system 1000 and/or the virtual-reality system 1100 may include micro-LED projectors that project light (using, e.g., a waveguide) into display devices, such as clear combiner lenses that allow ambient light to pass through. The display devices may refract the projected light toward a user’s pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, the augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user’s real-world experience in a variety of contexts and environments. For instance, artificial-reality systems may assist or extend a user’s perception, memory, or cognition within a particular environment. Some systems may enhance a user’s interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user’s artificial-reality experience in one or more of these contexts and environments and/or in other contexts and environments.

The following example embodiments are also included in this disclosure:

Example 1: A head-mounted display, which may include: a frame, a light projector coupled to the frame; a waveguide configured to direct images from the light projector to a user’s eye; and at least one flexure element coupled to the frame and physically supporting the waveguide in the frame.

Example 2: The head-mounted display of Example 1, wherein the at least one flexure element abuts against an outer peripheral edge of the waveguide to physically support the waveguide in the frame.

Example 3: The head-mounted display of Example 1 or Example 2, wherein each flexure element of the at least one flexure element comprises a flexible material configured to apply an inward biasing force against the waveguide.

Example 4: The head-mounted display of any of Examples 1 through 3, wherein the waveguide is at least partially transparent to visible light to enable the user to view a real-world environment through the waveguide.

Example 5: The head-mounted display of any of Examples 1 through 4, wherein the waveguide is separated from the light projector by a gap.

Example 6: The head-mounted display of any of Examples 1 through 5, wherein the at least one flexure element comprises three flexure elements.

Example 7: The head-mounted display of any of Examples 1 through 6, wherein the light projector comprises thee subprojectors, wherein each of the three subprojectors is configured to emit light of a different wavelength.

Example 8: The head-mounted display of any of Examples 1 through 7, wherein the waveguide comprises at least one input grating positioned adjacent to the light projector, wherein the at least one input grating is configured to enable light from the light projector to enter into the waveguide.

Example 9: The head-mounted display of any of Examples 1 through 8, wherein the waveguide comprises at least one fiducial mark to facilitate optical location and orientation sensing of the waveguide when assembling the waveguide to the frame.

Example 10: The head-mounted display of any of Examples 1 through 9, wherein the waveguide is further supported in the frame by an adhesive material.

Example 11: The head-mounted display of Example 10, wherein the adhesive material is positioned between the waveguide and the frame in at least three distinct locations.

Example 12: The head-mounted display of any of Examples 1 through 11, wherein the frame includes an eyeglasses frame.

Example 13: An optical assembly, which may include: a light projector configured to project an image for display to a user, the light projector coupled to a frame; and a waveguide held laterally in place relative to the frame and to the light projector by at least two flexure elements secured to the frame, each of the at least two flexure elements applying a holding force against a peripheral edge of the waveguide.

Example 14: The optical assembly of Example 13, wherein the at least two flexure elements include at least three flexure elements each secured to the frame and applying the holding force against the peripheral edge of the waveguide.

Example 15: The optical assembly of Example 13 or Example 14, wherein the waveguide includes at least one input grating optically aligned with at least one respective subprojector of the light projector.

Example 16: The optical assembly of Example 15, wherein the waveguide includes three input gratings optically aligned with three respective subprojectors of the light projector, wherein each of the three subprojectors is configured to project light of a different wavelength.

Example 17: The optical assembly of any of Examples 13 through 16, wherein each of the flexure elements includes two flexible arms extending away from a coupling point that secures the flexure element to the frame.

Example 18: A method of assembling a head-mounted display, which may include: mounting a waveguide to a frame with at least one flexure element coupled to the frame; laterally moving the waveguide relative to the frame to align at least one input grating of the waveguide with a light projector coupled to the frame; and fixing the waveguide to the frame in position with the at least one input grating aligned with the light projector.

Example 19: The method of Example 18, which may further include optically determining the position and orientation of the waveguide relative to the frame prior to fixing the waveguide to the frame.

Example 20: The method of Example 18 or Example 19, wherein the lateral movement of the waveguide flexes the at least one flexure element.

In some examples, the term “substantially” in reference to a given parameter, property, or condition, may refer to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or fully met.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A head-mounted display, comprising:
a frame;
a light projector coupled to the frame;
a waveguide configured to direct images from the light projector to a user’s eye; and
at least one flexure element coupled to the frame and physically supporting the waveguide in the frame.

2. The head-mounted display of claim 1, wherein the at least one flexure element abuts against an outer peripheral edge of the waveguide to physically support the waveguide in the frame.

3. The head-mounted display of claim 1, wherein each flexure element of the at least one flexure element comprises a flexible material configured to apply an inward biasing force against the waveguide.

4. The head-mounted display of claim 1, wherein the waveguide is at least partially transparent to visible light to enable the user to view a real-world environment through the waveguide.

5. The head-mounted display of claim 1, wherein the waveguide is separated from the light projector by a gap.

6. The head-mounted display of claim 1, wherein the at least one flexure element comprises at least three flexure elements.

7. The head-mounted display of claim 1, wherein the light projector comprises at least three subprojectors, wherein each of the three subprojectors is configured to emit light of a different wavelength.

8. The head-mounted display of claim 1, wherein the waveguide comprises at least one input grating positioned adjacent to the light projector, wherein the at least one input grating is configured to enable light from the light projector to enter into the waveguide.

9. The head-mounted display of claim 1, wherein the waveguide comprises at least one fiducial mark to facilitate optical location and orientation sensing of the waveguide when assembling the waveguide to the frame.

10. The head-mounted display of claim 1, wherein the waveguide is further supported in the frame by an adhesive material.

11. The head-mounted display of claim 10, wherein the adhesive material is positioned between the waveguide and the frame in at least three distinct locations.

12. The head-mounted display of claim 1, wherein the frame comprises an eyeglasses frame.

13. An optical assembly, comprising:
a light projector configured to project an image for display to a user, the light projector coupled to a frame; and
a waveguide held laterally in place relative to the frame and to the light projector by at least two flexure elements secured to the frame, each of the at least two flexure elements applying a holding force against a peripheral edge of the waveguide.

14. The optical assembly of claim 13, wherein the at least two flexure elements comprise at least three flexure elements each secured to the frame and applying the holding force against the peripheral edge of the waveguide.

15. The optical assembly of claim 13, wherein the waveguide comprises at least one input grating optically aligned with at least one respective subprojector of the light projector.

16. The optical assembly of claim 15, wherein the waveguide comprises three input gratings optically aligned with three respective subprojectors of the light projector, wherein each of the three subprojectors is configured to project light of a different wavelength.

17. The optical assembly of claim 13, wherein each of the flexure elements comprises two flexible arms extending away from a coupling point that secures the flexure element to the frame.

18. A method of assembling a head-mounted display, the method comprising:
mounting a waveguide to a frame with at least one flexure element coupled to the frame;
laterally moving the waveguide relative to the frame to align at least one input grating of the waveguide with a light projector coupled to the frame; and
fixing the waveguide to the frame in position with the at least one input grating aligned with the light projector.

19. The method of claim 18, further comprising optically determining the position and orientation of the waveguide relative to the frame prior to fixing the waveguide to the frame.

20. The method of claim 18, wherein the lateral movement of the waveguide flexes the at least one flexure element.
